(19) United States
(12) Patent Application Publication
(10) Pub. No.: US 2006/0062550 A1
(43) Pub. Date: Mar. 23, 2006

(54) Method and apparatus for consecutive recording of a series of broadcast programs

(75) Inventor: Jung Gu Lee, Boosan-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/033,125

(22) Filed: Jan. 12, 2005

(30) Foreign Application Priority Data
Sep. 23, 2004 (KR) 10-2004-0076279

(51) Int. Cl. H04N 5/91

(52) U.S. Cl. 386/83

(57) ABSTRACT

A method and apparatus for controlling of consecutive recoding of a series of broadcast programs are provided. In a digital broadcast signal receiver, in response to a request of recording a particular series of broadcast programs, it is determined whether or not a program being tuned is one episode of the series. If it is determined that the program is one episode of the series, the program is recorded automatically in a pre-allocated storage space that has been reserved for either the single episode or all of the episodes of the series.

### BACKGROUND OF THE INVENTION

1. Field of the Invention

The invention relates to a method and apparatus for recording broadcast programs, and more particularly, to a method and apparatus for recording a series of broadcast programs consecutively.

2. Background of the Related Art

Digital broadcast signal receivers, like set top box in step (STB), receive digital broadcast signals in the form of MPEG transport stream (TS), demodulate them into video/audio signals, and transmit the video/audio signals to a TV set or external display so that viewers can choose and watch a particular program from many channels, selectively. Further, the digital broadcast signal receivers enable a viewer to record a particular program on a high-capacity hard disk drive therein and to replay the recorded program at viewer's convenience.

On the other hand, TV broadcast system companies provide viewers with various genres of programs, such as drama, movie, amusements, and documentaries, to satisfy viewer's various needs. While taking program characteristics into consideration, broadcast program producers have a tendency to produce and provide a series of programs to get and maintain a high audience rating.

To record a series of broadcast programs, viewers have to record each episode of the series at its broadcast time one by one by entering record commands, for example, using remote controller. However, viewers often fail to record an episode of the series.

### SUMMARY OF THE INVENTION

An object of the invention is to solve at least the above problems and/or disadvantages and to provide at least the advantages described hereinafter.

In order to achieve at least the above objects, in whole or in part, and in accordance with the purposes of the invention, as embodied and broadly described herein, there is provided a method of recording a series of broadcast programs consecutively in accordance with an embodiment of the invention that includes receiving a request for recording a particular series of broadcast programs, determining whether or not a program pertains to the series of broadcast programs, allocating a storage space required to record all of the episodes of the series of broadcast programs in advance so that all of the episodes can be recorded consecutively in the allocated storage space, and recording the program if it is determined that the program pertains to the series of broadcast programs.

To further achieve at least the above objects, in whole or in part, and in accordance with the purposes of the invention, as embodied and broadly described herein, there is provided a method of recording a series of broadcast programs consecutively in accordance with an embodiment of the invention that includes receiving a request for recording a particular series of broadcast programs, determining whether or not a program pertains to the series of broadcast programs, recording the program if it is determined that the program pertains to the series of broadcast programs, and creating and writing a play item in a play list after recording each episode of the series, the play item being associated with the recorded episode and being added to the play list.

To further achieve at least the above objects, in whole or in part, and in accordance with the purposes of the invention, as embodied and broadly described herein, there is provided an apparatus for consecutively recording a series of broadcast programs in accordance with an embodiment of the invention that includes an input device configured to receive a user command, a tuner configured to tune a broadcasting channel, a storage device configured to store programs from the tuned channel, a decoder configured to produce audio/video signals by decoding audio/video data received from the tuned channel or stored in the storage device, a controller configured to determine whether or not a program being tuned by the tuner pertains to a series of broadcast programs if a request for recording the series of broadcast programs is received by the input device, and record the program being tuned in the storage device if it is determined that the program being tuned pertains to the series of broadcast programs, wherein the controller allocates a storage space in the storage device in advance to provide a recording space for all of the episodes of the series of broadcast programs so that all of the episodes can be recorded consecutively in the allocated storage space.

To further achieve at least the above objects, in whole or in part, and in accordance with the purposes of the invention, as embodied and broadly described herein, there is provided an apparatus for consecutively recording a series of broadcast programs in accordance with an embodiment of the invention that includes an input device configured to receive a user command, a tuner configured to tune a broadcasting channel, a storage device configured to store programs from the tuned channel, a decoder configured to produce audio/video signals by decoding audio/video data received from the tuned channel or stored in the storage device, a controller configured to determine whether or not a program being tuned by the tuner pertains to a series of broadcast programs if a request for recording the series of broadcast programs is received by the input device, and record the program being tuned in the storage device if it is determined that the program being tuned pertains to the series of broadcast programs, wherein the controller creates and writes a play item in a play list after recording the program, the play item being associated with the recorded program and being added to the play list.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram of a digital broadcast signal receiver in accordance with an embodiment of the invention;

FIG. 2 is a view showing PSIP information included in a transport stream of digital broadcast signals in accordance with an embodiment of the invention;

FIG. 3 is a view showing that, based on the PSIP information, a series of broadcast programs are recorded consecutively in a pre-allocated space on a hard disk drive in a receiver in accordance with an embodiment of the invention;

FIG. 4 is a view showing that, based on the PSIP information, a series of broadcast programs are recorded separately on a hard disk drive in a receiver in accordance with another embodiment of the invention;

FIG. 5 is a view showing a playlist including play items, each related to one episode of a series of broadcast programs, in accordance with another embodiment of the invention;

FIG. 6 is a menu screen display in which a user can choose an episode of a series of broadcast programs already recorded in accordance with another embodiment of the invention;

FIG. 7 is a flowchart of a method for recording a series of broadcast programs in accordance with an embodiment of the invention; and

FIG. 8 is a flowchart of a method for recording a series of broadcast programs in accordance with another embodiment of the invention.

### DETAILED DESCRIPTION OF PREFERRED EMBODIMENTS

Now, a method and apparatus for consecutive recording of a series of broadcasting programs in accordance with embodiments of the invention will be described in detail with reference to the drawings, in which like reference numerals have been used to designate like elements.

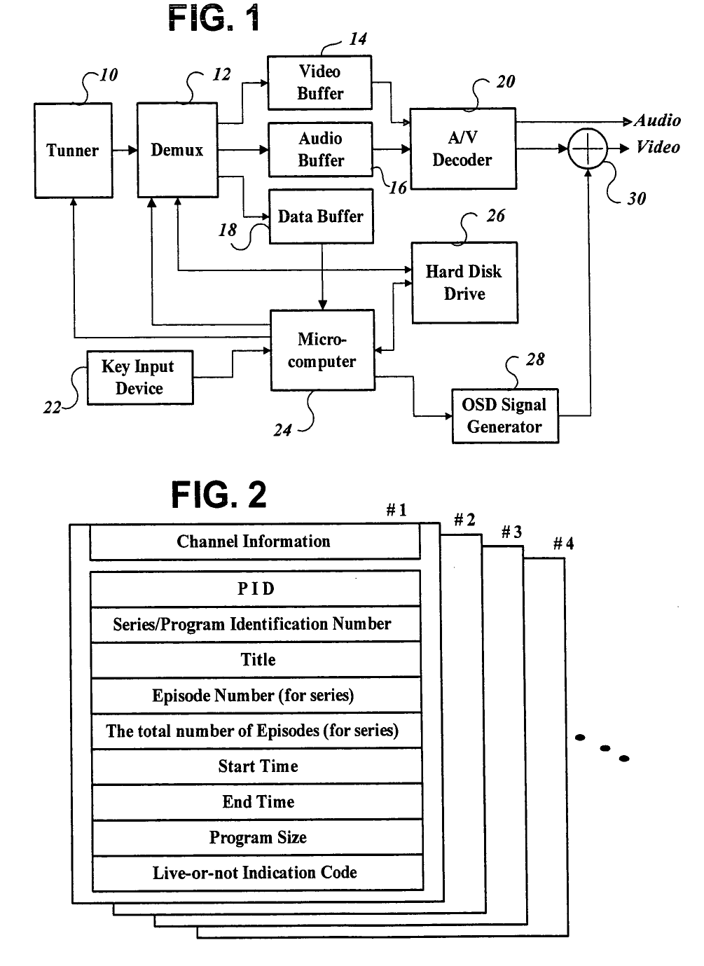

FIG. 1 is a block diagram of a digital broadcast signal receiver apparatus, such as a set top box in step (STB), in accordance with an embodiment of the invention. The digital broadcast signal receiver apparatus includes a tuner 10 for tuning a broadcast channel; a demux 12 for demuxing data streams from the tuned channel source by source; a video buffer 14 for buffering video packets; an audio buffer 16 for buffering audio packets; a data buffer 18 for buffering management information-related packets; an audio/video (A/V) decoder 20 for decoding video and audio packets; a key inputting device 22 for receiving commands from users; a microcomputer 24 for performing overall control operations to receive and record broadcast signals; a high-capacity hard disk drive 26 for providing storage space for recording broadcast signals; an OSD signal generator 28 for generating character and graphic signals; and a signal summer 30 for summing and producing video signals.

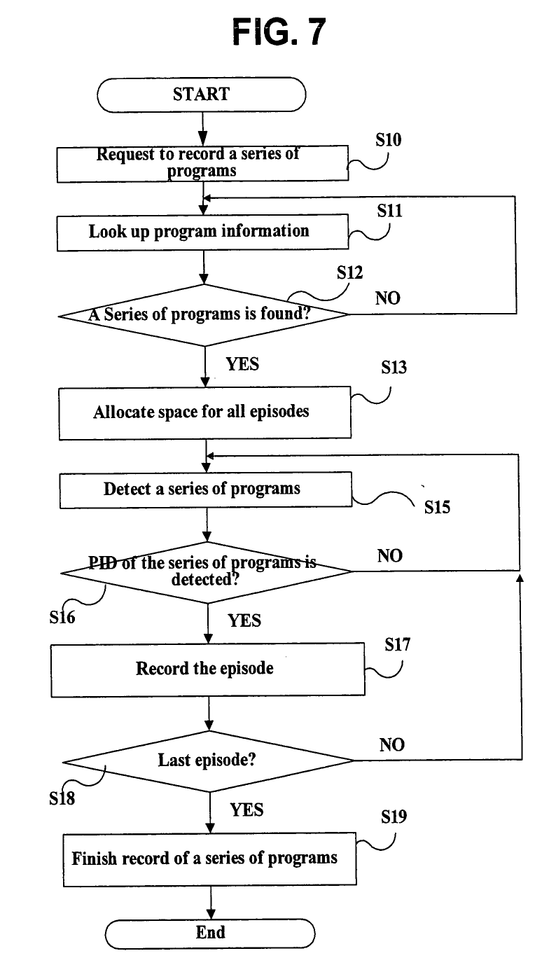

FIG. 7 is a flowchart of a method for recording a series of broadcast programs in accordance with an embodiment of the invention, which will be described below in detail with reference to the receiver of FIG. 1. However, the method in accordance with embodiments of the invention may be implemented in other type receivers.

A user's command is input from the key input device 22 to request to record an episode of a particular series of programs, in step S10. In step S10, a program identification number (PIN) or series identification number (SIN) may be input, for example. In order to distinguish recording of a series of programs from recording of a single program, a separate command key may be provided or a menu display may be generated by the microcomputer 24 and the OSD signal generator 28. The menu screen display may provide two touch buttons, for example: ‘recording a series of programs’ and ‘recording a single program’. Either a PIN or a SIN input by a user may be recorded by the microcomputer 24.

On the other hand, when broadcast digital signals are tuned from a chosen channel by the tuner 10, the demux 12 parses MPEG transport streams in the tuned signals into video, audio, and data transport packets, depacketizes them into PES packets, and stores the PES packets in the video, audio, and data buffers, respectively. At this time, the management data included in payload fields of transport packets with a predetermined packet identification (PID), for example, 00, may be depacketized into PES packets and stored in the data buffer 18. The management PES packet is commonly called program and system information packet (PSIP) and may include fields that contains broadcast program information.

FIG. 2 illustrates a broadcast program information in a PSIP that includes, for example, channel information, a PID of the transport packets carrying the program, a SIN/PIN, a title of a series of programs or a single program, a start time, an end time, an episode number (for a series of programs), a number of episodes (for a series of programs), program size information that represents the total size of the program, and a live indication code that represents whether the program is live or replay and is used to prevent a duplicate program from being recorded. The program information in the PSIP may be stored in the hard disk drive 26 and referenced when needed.

Once a request for recording a series of programs is given, in step S10, a SIN of the series is looked up in the broadcast program information of FIG. 2 stored in the hard disk drive 26, in step S11. If the SIN is found, in step S12, start time and end time of the program are obtained. If the receiver is in the power-saving mode or power-off mode, the receiver may be in the power-off mode until the start time of the program.

Based on the number of episodes and the episode number of the program being tuned, the microcomputer 24 calculates the total recording time or total recording volume that is approximately required to record all of the episodes of the series, and allocates a storage space on the hard disk drive 26 that amounts to the total recording volume, in step S13. For instance, if the number of episodes is 36 and the episode number is 12, and if program size is ˜700 Mb, then ˜17.5 GB (=(36−12+1)×700) is allocated in the hard disk drive 26. The allocated storage space is used exclusively for recording the series of programs requested.

Once a storage space is allocated, the microcomputer 24 determine whether or not an episode of the series is broadcast by tuning the tuner 10 to a desired broadcast channel based on the start time and live indication code in the broadcast information stored in the hard disk drive 26, in step S15. It is determined in the demux operation by the demux 12 whether or not a transport packet whose PID is identical to that of the episode requested for recording is detected, in step S16. When the live indication code represents replay, channel tuning and PID detection in the demuxing are not executed. Instead of using the live indication code, the episode number of the last episode recorded may be memorized and used to determine whether to record the episode being tuned by comparing the two episode numbers. If they are the same, the episode being tuned is not recorded because the episode is a replay.

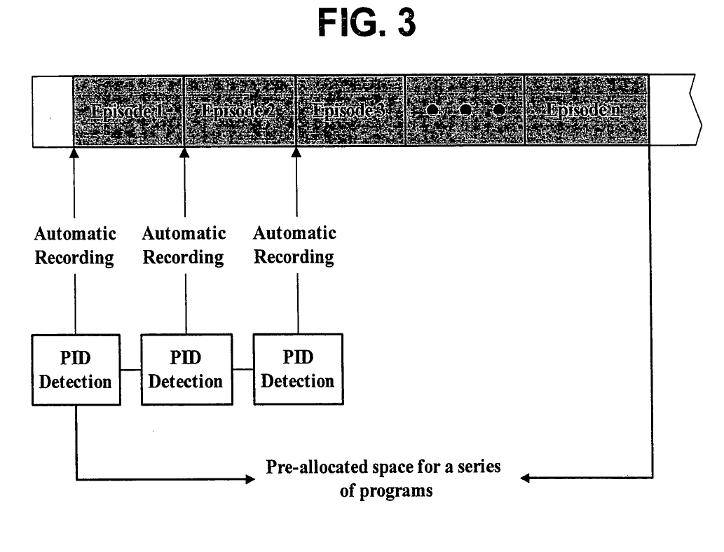

If it is determined that the transport packet has a PID that is the same as that of the episode, the episode being tuned starts to be recorded in the allocated storage space, in step S17, as shown in FIG. 3. In step S17, the episode is recorded in the form of transport packets without a demuxing or decoding operation. When reproduced, transport packets of the episode that have been recorded this way are decoded into A/V data by the demux 12 and the decoder 20. After the recording of one episode is completed, the microcomputer 24 determines if the episode is the final episode or not by comparing the episode number with the total number of episodes, in step S18.

If it is determined that the episode recorded is not the final episode, steps S15 through S17 are repeated until the final episode is recorded so that the series of programs is recorded in a consecutive storage space, automatically. If the final episode is confirmed in step S18, the series recording mode is turned off, in step S19.

Once recording of a series of programs is complete, general information such as the title of the series, the number of episodes recorded, and an address in the allocated storage space at which the first episode is recorded, are written to the hard disk drive 26. Upon a user's request, the general information is displayed on a screen of an external device, such as a TV, by sending them to the OSD signal generator 28 so that a user can choose one or more from a series of programs recorded previously.

If a user selects a series of programs to watch using the key input device 22, the corresponding transport packets are read out from the storage address at which the first episode was recorded in the hard disk drive 26 and are then supplied to the demux 12 sequentially so that they are decoded into video and audio PES packets to generate A/V signals by the decoder 20. In this way, for a single playback request, the full episodes recorded consecutively can be played back continuously.

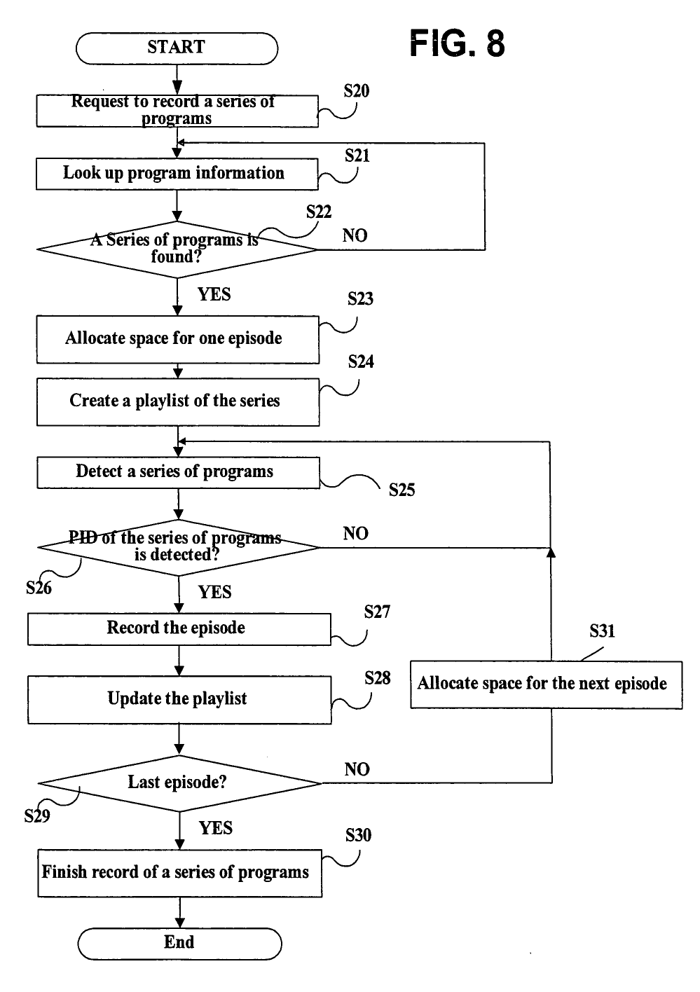

Now, another embodiment of the invention is described in detail with reference to the flowchart of FIG. 8 and the receiver of FIG. 1. Again, the method in accordance with embodiments of the invention may be implemented in other type receivers.

When a user's command is input using the key input device 22 to request to record an episode of a particular series of programs, in step S20, a PIN or SIN is input. In order to distinguish recording of a series of programs from recording of a single program, a separate command key is provided, for example, on a menu display which may be generated by the microcomputer 24 and the OSD signal generator 28. The menu screen display may provide, for example, two touch buttons: ‘recording a series of programs’ and ‘recording a single program’. Next, a SIN of the series is looked up in the broadcast program information of FIG. 2 stored in the hard disk drive 26, in step S21. If the SIN is found, in step S22, it is determined whether the episode being tuned is live or a replay. If it is live, a storage space that is required to record this episode is allocated in the hard disk drive 26 based on the program size information, in step S23.

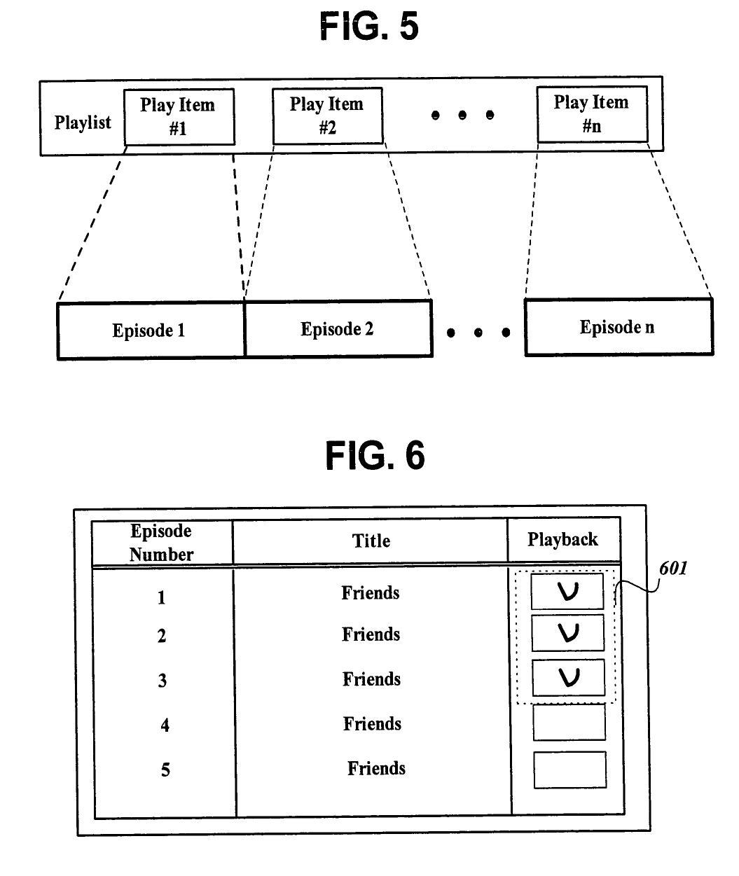

In addition, a playlist may be created and recorded in the hard disk drive 26 to enable indexing the episodes of the series, in step S24. As shown in FIG. 5, each time one episode of the series is recorded, one play item is added into the playlist associated with the series.

Once a storage space is allocated, the microcomputer 24 determines whether or not an episode of the series is broadcast by tuning the tuner 10 to a desired broadcast channel based on the start time and a live indication code in the broadcast information stored in the hard disk drive 26, in step S22. It is determined in the demux operation by the demux 12 whether or not transport packet whose PID is identical to that of the episode requested for recording is detected, in step S26.

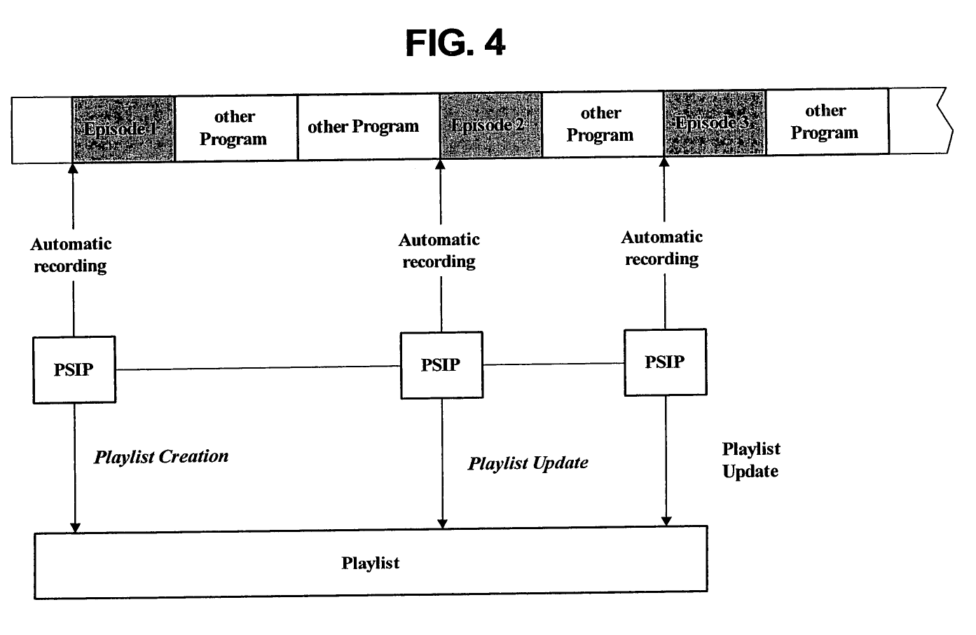

If it is determined that the transport packet has a PID which is the same as that of the episode, the episode being tuned starts to be recorded in the allocated storage space, in step S27, as shown in FIG. 4. In step S17, the episode is recorded in the form of transport packets that are bypassed outputs of the demux 12, namely not-demuxed transport packets.

After recording is complete, the microcomputer 24 creates and adds a play item to the playlist corresponding to the series, in step S28. The play item that is associated with the episode just recorded may include, among other things, the title, the episode number, the size, and the location information on the recorded area.

Then, the microcomputer 24 determines if the episode is the final episode or not by comparing the episode number with the total number of episodes that is stored the broadcast program information in the hard disk drive 26, in step S29. If it is determined that the episode recorded is not the final episode, a storage space is allocated in the hard disk drive 26 in advance for the next episode, in step S31, and then steps S25 through S28 are repeated until the final episode is recorded completely. If the program information on the next episode is not available in step S31, the program information of the last episode recorded is used to allocate a space for the next episode. If the final episode is confirmed in step S29, the series program recording mode is turned off, in step S30.

After the recording of a series of programs is complete, all of the episodes are recorded in the hard disk drive 26, as shown in FIG. 4 and a playlist is created to link all of the episodes together. In this embodiment, each time one episode is recorded, a storage space is newly allocated in the hard disk drive 26 for the episode. Hence, if a user's request is made between two episodes of the series, other programs may be recorded between storage spaces of the two episodes in the hard disk drive 26, as shown in FIG. 4.

Therefore, as shown in FIG. 5, the microcomputer 24 creates a playlist to link all of the episodes together and records the playlist in the hard disk drive 26 so that a user can watch a full series as if provided as a single program. Each episode is associated with one of the play items in the playlist.

Upon a user's request, a list of the playlists can be displayed on a screen by the OSD signal generator 28. In response to a request of playback of one playlist among them, the episodes may be retrieved sequentially from the hard disk drive 26 by referencing play items in the chosen playlist and may then be converted into audio/video signals by the demux 12 and the decoder 20. In this way, a full series of episodes separately recorded in the hard disk drive 26 can be played back continuously upon a single request.

By using the playlist, one or more episodes of the series may be played back selectively. For example, when a request is made to display a list of all episodes, the microcomputer 24 may display a list of episodes, shown in FIG. 6, by using the OSD signal generator 28. On the list on a screen, a user may choose episode(s) (marked ‘601’) to watch selectively by using the key inputting device 22, and the selected episodes are played back by the microcomputer 24.

The method and apparatus according to embodiments of the invention provide at least the following advantages.

The method and apparatus according to embodiments of the invention allow a viewer automatically to record a series of broadcast programs consecutively, in a digital broadcast signal receiver apparatus.

Further, the method and apparatus according to embodiments of the invention allow a viewer to continuously reproduce a series of broadcast programs recorded in a digital broadcast signal receiver apparatus in response to the viewer's request.

Thus, the method and apparatus according to embodiments of the invention provide a convenient way of recording a series of programs consecutively, automatically without requests for recording every episode.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of recording a series of broadcast programs consecutively, comprising:
receiving a request for recording a particular series of broadcast programs;
determining whether or not a program pertains to the series of broadcast programs;
allocating a storage space required to record all of the episodes of the series of broadcast programs in advance so that all of the episodes can be recorded consecutively in the allocated storage space; and
recording the program if it is determined that the program pertains to the series of broadcast programs.

2. The method as set forth in claim 1, wherein whether or not a program pertains to the series of broadcast programs is determined based on a series program identification number and a broadcast program information listing all of the programs that are tunable, the broadcast program information being received before the receiving step.

3. The method as set forth in claim 2, wherein the broadcast program information includes, for each program, a program packet identification, a program or series identification number, a title, a start time, an end time, and a program data size, the broadcast program information further including an episode number and the total number of episodes if a program is one episode of a series of programs.

4. The method as set forth in claim 2, wherein whether or not a program pertains to the series of broadcast programs is determined by detecting data packets whose packet ID is equal to a packet ID indicative of the series of broadcast programs obtained from the broadcast program information, when a program having the series program identification number is found in the broadcast program information.

5. The method as set forth in claim 1, further comprising creating and writing a play item in a play list after recording each episode of the series, the play item being associated with the recorded episode and being added to the play list.

6. The method as set forth in claim 1, wherein in the recording step, recording of the program pertaining to the series is performed only after it is determined that the program has not been previously recorded.

7. A method of recording a series of broadcast programs consecutively, comprising:
receiving a request for recording a particular series of broadcast programs;
determining whether or not a program pertains to the series of broadcast programs;
recording the program if it is determined that the program pertains to the series of broadcast programs; and
creating and writing a play item in a play list after recording each episode of the series, the play item being associated with the recorded episode and being added to the play list.

8. In a digital broadcast signal receiver apparatus, an apparatus for consecutively recording a series of broadcast programs, comprising:
an input device configured to receive a user command;
a tuner configured to tune a broadcasting channel;
a storage device configured to store programs from the tuned channel;
a decoder configured to produce audio/video signals by decoding audio/video data received from the tuned channel or stored in the storage device;
a controller configured to determine whether or not a program being tuned by the tuner pertains to a series of broadcast programs if a request for recording the series of broadcast programs is received by the input device, and record the program being tuned in the storage device if it is determined that the program being tuned pertains to the series of broadcast programs, wherein the controller allocates a storage space in the storage device in advance to provide a recording space for all of the episodes of the series of broadcast programs so that all of the episodes can be recorded consecutively in the allocated storage space.

9. The apparatus as set forth in claim 8, wherein prior to recording, the controller allocates a storage space in the storage device by obtaining program data size information from a broadcast program information about the program being tuned and records the program being tuned in the allocated space, the broadcast program information having been tuned and stored in the storage device.

10. The apparatus as set forth in claim 8, wherein the controller creates and writes a play item in a play list after recording the program, the play item being associated with the recorded program and being added to the play list.

11. In a digital broadcast signal receiver apparatus, an apparatus for consecutively recording a series of broadcast programs, comprising:
an input device configured to receive a user command;
a tuner configured to tune a broadcasting channel;
a storage device configured to store programs from the tuned channel;
a decoder configured to produce audio/video signals by decoding audio/video data received from the tuned channel or stored in the storage device;
a controller configured to determine whether or not a program being tuned by the tuner pertains to a series of broadcast programs if a request for recording the series of broadcast programs is received by the input device, and record the program being tuned in the storage device if it is determined that the program being tuned pertains to the series of broadcast programs, wherein the controller creates and writes a play item in a play list after recording the program, the play item being associated with the recorded program and being added to the play list.
